(19) United States
(12) Patent Application Publication
(10) Pub. No.: US 2020/0183980 A1
(43) Pub. Date: Jun. 11, 2020

(54) SYSTEM AND METHOD FOR CREATING A FAMILY GRAPH IN DIGITAL FORM

(71) Applicant: James R. Barkow, Ross, CA (US)

(72) Inventor: James R. Barkow, Ross, CA (US)

(21) Appl. No.: 16/214,911

(22) Filed: Dec. 10, 2018

(51) Int. Cl. G06F 16/904; G06F 16/9535; G06F 16/901; G06F 3/0484

(52) U.S. Cl. CPC G06F 16/904; G06F 3/0484; G06F 16/9024; G06F 16/9535

(57) ABSTRACT

A method for displaying family relationships including a collection of identifying information about an individual, the creation of a first individual user profile, collection of identifying information about at least one family member of the individual, and the creation of a first family profile in which family relationships are connected and displayed in a circular format in a family graph.

### BACKGROUND

### 1. Field of the Invention

The present invention relates generally to a system and method for creating a family graph in digital form.

### SUMMARY OF THE INVENTION

The present invention is directed to a system and method for collecting and generating a self-centric, dynamic and infinite family graph from individual family members in a software application environment, whether on a mobile or web application, with the purpose of generating an extended family graph which is defined as a family structure or profile that includes a user's family tree as well as the family tree of included spouses throughout the user's family tree. Essentially, it is a database that includes a user's family relationships (including in-laws), not just direct blood relatives.

In one embodiment, the method includes the process of collecting family relationship information from individuals, using that information to generate an adjacency database or other suitable backend implementation, and then generating a graphic display of this information on a mobile device or web app. A key advantage of this process is that it allows a user to collect the relationships one time and then generate a family graph centered around any one of the specific individuals located within the family graph. For example, if a user who is designated as a “father” sets up a family graph that includes several generations of extended family, a “son” of that father could log in to that same family graph under his unique login and the family graph will automatically update all the relationship titles to each extended family member. Thus, in the father's profile wherein the relationship to his parent's other children would read sister and brother, when the son would login, the individuals would then read aunt and uncle, etc.

It will be appreciated that the method is configured to automatically create a nuclear family, determine and name a family relationship across multiple degrees of separation, for example, automatically identify a second cousin. A user can then view a scrollable family graph, zooming and or out to expand the visual representation out as far as connections are present. Essentially, the relationships auto-connect a user that joins one family to every possible connection in a family graph such that once a user establishes at least one relationship the family graph auto-generates all other possible relationships to other individuals in the family graph. Additionally, the family graph is user-centric so that is it centered around any user that is currently logged in. This differs from a standard family tree in which relationships expand linearly upward from a single point defined by the user.

It will also be appreciated that the family graph is a dynamic means that any user can change, make additions or deletions or edits, that are then reflected in the family graph. The visual display of the family graph is centric to an individual user and/or his/her family and expands outwards.

In one embodiment, the primary function of the invention is to graphically create and display a user's living and potentially deceased family members.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIGS. 1-12 depict various views of the system and method of use of a preferred embodiment of the present invention.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developers specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

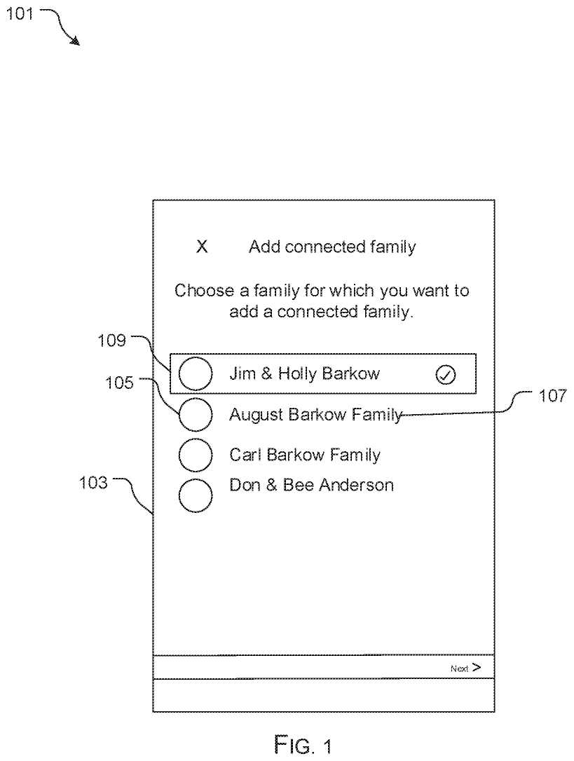

Referring now to the drawings wherein like reference characters identify corresponding or similar elements throughout the several views, FIGS. 1-12 depict various views of a system and method of use in accordance with a preferred embodiment of the present application.

The system includes the features of a visual display of the family graph that is presented to a user, wherein the family graph may be dynamically updated via the graphical family representation. For example, the family graph representation may include an interface functionality that allows a user to perform any one or a combination of the following: selecting family members, updating and/or modifying the family graph, or editing one or more display options with respect to how the family graph is represented and displayed.

Some embodiments include a method for interacting with a representation of a family graph. The method comprises receiving family graph information from a user with respect to the family graph, displaying a representation of the family graph based, at least in part, on the received family graph information, receiving updated information from the user indicating at least one modification to the family graph and/or the family graph representation, the updated information received via the user interacting directly with the graphical representation of the family graph, performing the at least one modification to the family graph and/or family graph representation, and displaying a representation of the family graph with the at least one modification.

A main advantage of the present invention is to automatically generate relationships across a nuclear and infinite extended family. The interface of the family graph can then be configured to allow messaging and the ability to share content across individuals and families inside the family graph.

The method of collection is comprised of the following steps: 1) user creates his/her profile 2) User either creates new Family or Joins existing family 3a) if creating a new family, the nuclear family is automatically create and user can edit the family profile 3b) if joining an existing family, user can search for his/her family and then request to join 4) once user has created new family or joined a family, user can add family members 5a) if relationship means the new user is in a new nuclear family, the new family is automatically created, thus extending the family graph 5b) extended family is created by a different user 6) software automatically links families based on names and using at least 1 overlapping family member. For example, a first user may be a member of first family (immediate family) and a second family (such as a parent's family). By being a member of both families, the software automatically creates a connection between the families and auto-generates all relationships (grandparents, aunts/uncles, etc). This same method is extended with the addition of extended families—such as mother's sisters' families creating a recognition as “aunt's families” for a son of the mother without additional action by the user.

Aside from generating the family graph, a user may access these relationships to enable messaging and content sharing on an individual but also on a family level. For example, a user can auto-generate a full family chat without inputting users' names or finding contact information.

The family graph also organizes users into a closed social network. This level of privacy allows for children to participate in messaging and content sharing in a trusted environment. As an additional advantage, users, such as younger children, who do not have a cell phone number or email address may still be able to create an account profile without that information and interact with approved family members in the family graph.

The method graphically organized users into families and shows relationships connecting users and families together. This method allows for the Family of the user to create a Family profile and then to automatically generate a full family graph consisting of multiple family profiles.

A summary of advantages of the present invention includes but is not limited to: Automatic generation of nuclear family in graphic form for web or mobile consumer app; Automatic generation of relationships extending from any user to any related user from a single relationship identification (i.e.—If a user indicates they are the son of his/her parents, the software automatically generate the relationship identification to that users grandparents, cousins, 2^{nd} cousins, etc. as long as those users are imputed in system); Individual user centric in that the software generates the family graph in relation to the specific user logged in; The family graph software is dynamic and propagates any changes to the family graph across all users; The graphical representation of the family graph presents each nuclear family as a circle instead of in traditional hierarchical format; and the User can zoom in or out as well as scroll any direction as they'd like starting his/her nuclear family.

The family graph includes historical relationships, such as deceased relatives. Additionally, the family graph includes any family connection no matter the number of connections. For example, a user may be able to locate a 10^{th} cousin or even further extended relative.

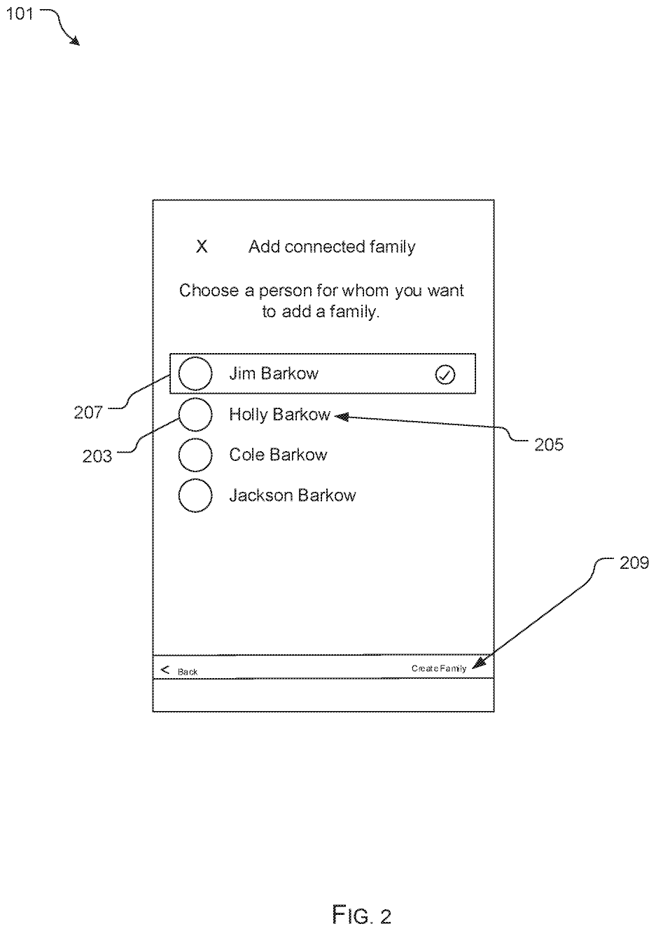

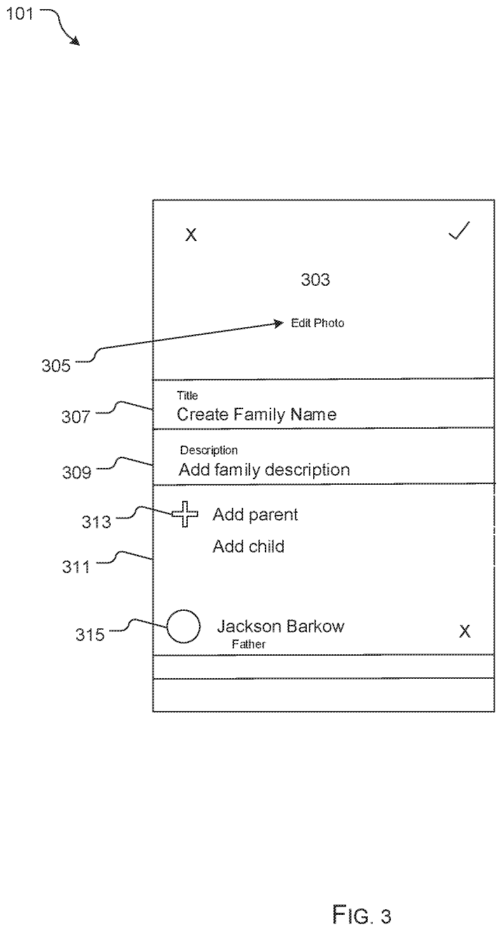

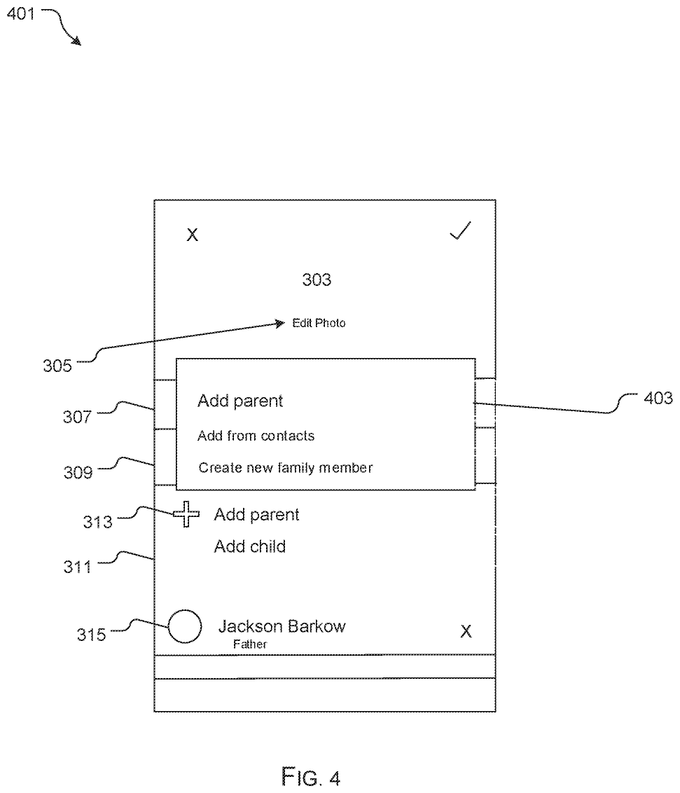

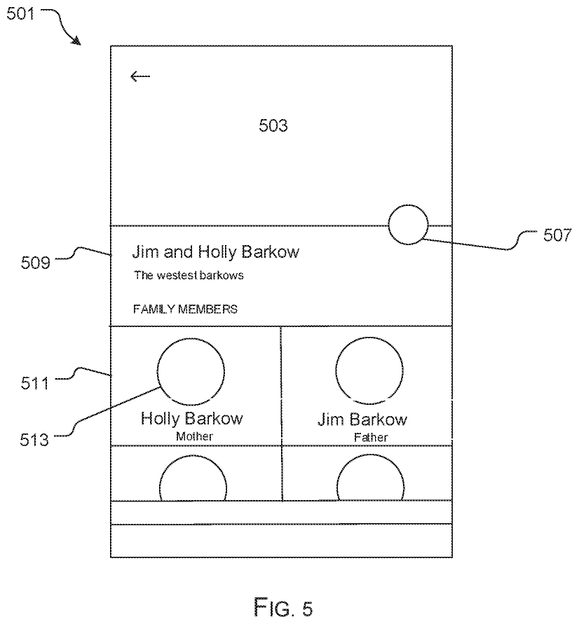

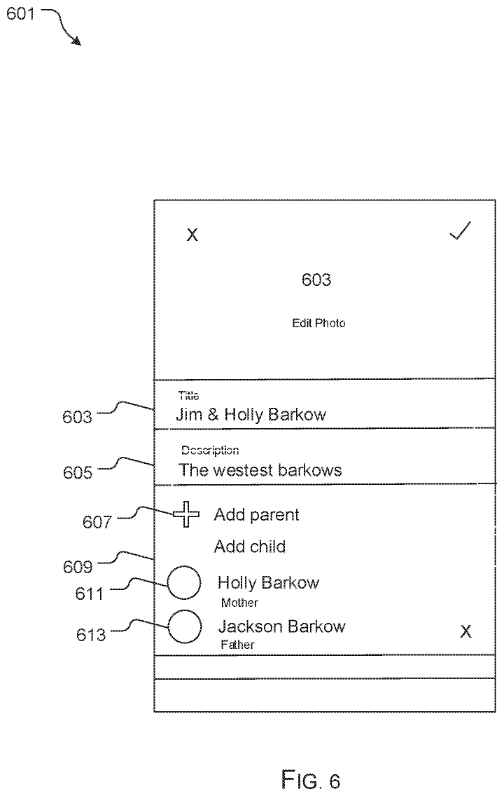

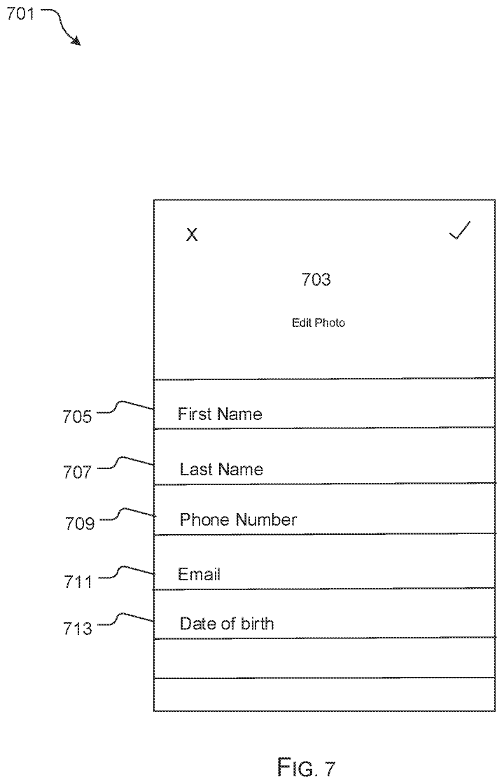

In FIG. 1, a plurality of family members is connected via the app. System 101 is an illustration of how to connect a first family to a second family. System 101 is shown having a plurality of families with a photo identifier 105 and textual description 107. A user may select a family 109 to then connect another family. In FIG. 2, the option to choose a person for whom a user wishes to add a family is shown having a plurality of individual users with a photo identifier 203 and textual description of the name 205. A user may select a particular individual 207 and then click “Create Family” 209 to then add a family to the selected user 207. FIG. 3 shows the option to further define the newly created family including a photo 303 with the option to edit the photo 305. A user may define a title to create a family name 307, a description to add a family description 309, and also add additional family members 311 via the add button 313. In FIG. 4, specific members are added via one or more means such as from contract and/or creating new family member information via the pop up box 403 having options to add a parent from contacts or create a new family member. In FIG. 5, user profile information is added such as a picture 503, family title and family description 509, family members 511, family timeline of events, and user relation in family (father, son) wherein a family profile is created, thus a first nuclear family can communicate or interact via the family profile with a second nuclear family having a family profile; In one embodiment, the family profile may be created from information gathered from a separate platform such as Famlicious. In FIG. 6, the selection of family member is made and added to the family that has been created. In FIG. 7, parent or child user information is added as a new family member, including the collection of the following information: a first name 705, a last name 707, a phone number 709, an email 711, and date of birth 713. It can be appreciated that a user may be added with only a first name, last name and date of birth, such as children who do not have a phone number or email.

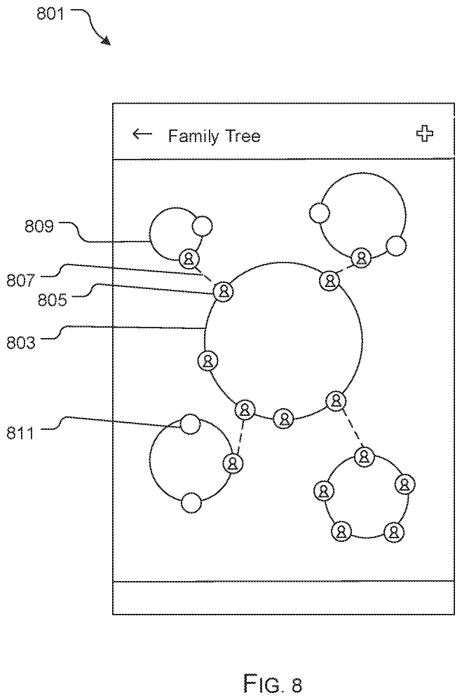

Referring specifically to FIG. 8, some of the unique features believed characteristic of the invention is a visual family graph. The figure illustrates a graphic representation of the family graph for the user in a mobile app, including the features of: (1) The users Nuclear family is in the center circle 803, (2) Connected families are connected via a dotted line or other suitable graphical indication of connection 807 (3) Connected families 809 start from any member of the nuclear family 805; (4) Connected families are also nuclear families wherein a nuclear family can be created from at least one user; (5) User can scroll any direction; (6) User can zoom in or out; and (7) User can click on any family and see that Family's profile. A defined member of a family is shown via a photograph such as in 805, whereas new family members can be added and defined via icons such as 811.

Wherein one user process flow for creation and manipulation of the family graph is textual in nature, there also exists an embodiment wherein the user process flow is visually manipulated. In an alternate embodiment, the data necessary to generate a family graph may be facilitated through the use of a chat box and associated chat bot or live person in communication with the user via the chat box.

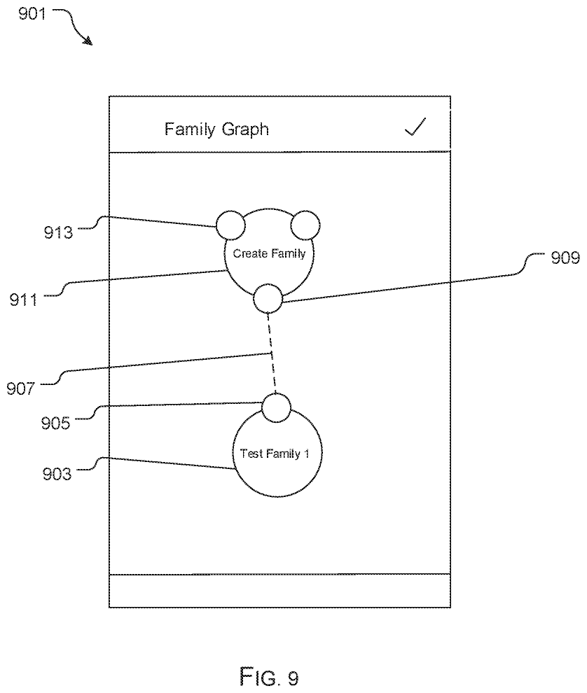

Referring now to FIG. 9-12, a similar method as described above is presented as a visual method of the family graph creation and use. Referring now to FIG. 9, a first user 905 in a new family may sign up for a personal profile. That user may then create his or her family. Once the family is created, the user is presented with a family graph 901. In the figure, the circle labeled test family 903 is designated as the first user's family. The dotted line 907 is the relationship connecting the first family 903 to a second family 911 wherein the user is identified as “Dad” in the first family and as “Son” in the second family. The button labeled “create family” in circle 911 allows the user to create and input individuals 913 into the second family circle 911.

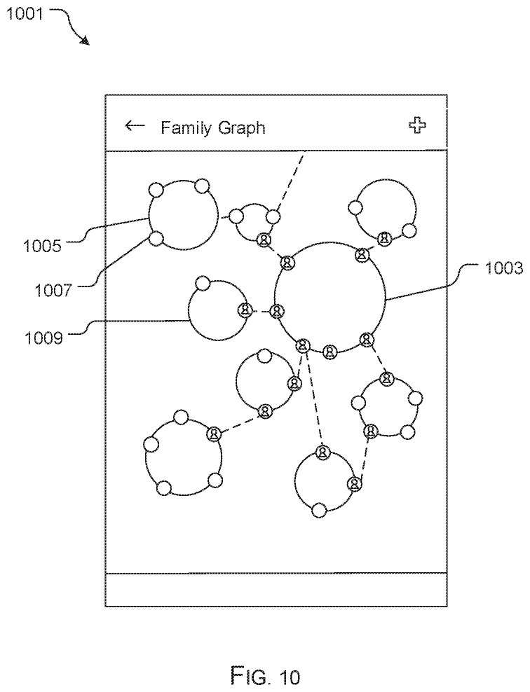

Referring now to FIG. 10, a family graph 1001 is shown having a full visual map of the user's family graph. Features of the family graph include that the map is self-centric to the user who is currently logged in showing his or her nuclear family 1003. The user may scroll through the family map and zoom in or out to expand or compress the family graph. The dotted lines represent a connection or relationship of a user between at least two families. The graph allows the incorporation of in-law families 1005. Families are represented as circles with a user inside each smaller circle around the circumference of the larger family circle. To add a new family, the user may open any potential family connection in the user's family graph. The user may then select the family that the new family should be connected to. Once the new family 1009, 1005 is created, additional individuals such as 1007 may be added to the family. It should be noted that a family can be a minimum of one user or individual.

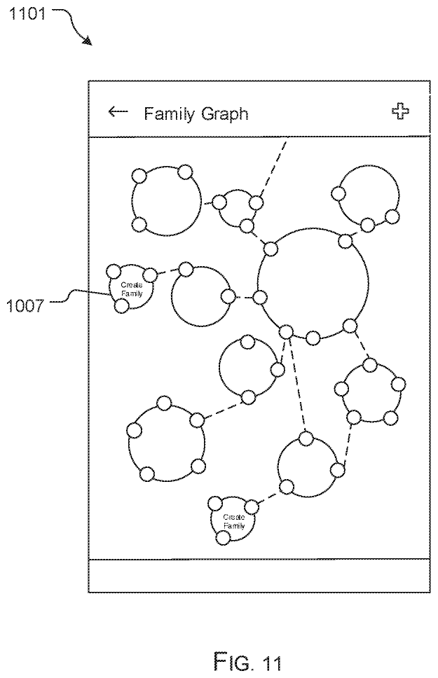

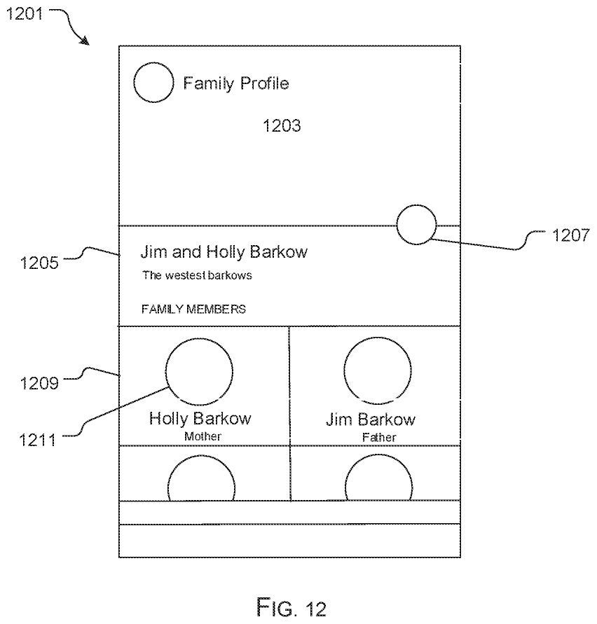

Referring now to FIG. 11, a screenshot of the process to add a new family is displayed. When a user opens an existing family graph, the graph opens any potential family connection located within the user's family graph. The user may then add a new family by clicking on the digital button that is labeled “Create New Family.” 1007 The user may then select the family the new family is connected to. Once the family entity is created, additional individuals or users may be added into the new family. Referring to FIG. 12, a depiction of the family profile is shown having a photo 1203, an option to direct the user to the family graph 1207, a information section 1205, and information about each family member 1209 including a photograph 1211.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description.

Although the present embodiments are shown above, they are not limited to just these embodiments, but are amenable to various changes and modifications without departing from the spirit thereof.

1. A method for displaying family relationships comprising:
collection of identifying information about an individual;
the creation of a first individual user profile;
collection of identifying information about at least one family member of the individual; and
the creation of a first family profile;
wherein family relationships are connected and displayed in a circular format in a family graph.

2. The method for displaying family relationships of claim 1 further comprising:
collection of identifying information about at least one extended family member of the individual including but not limited to a grandparent, a spouse of a sibling, a mother of a spouse of the individual; and
the creation of a second family profile;
wherein the second family profile is shown as family relationships displayed in a circular format in the family graph; and
wherein the first and second families are connected via a graphical connection as displayed in the family graph.

3. The method for displaying family relationships of claim 1, wherein the individual of claim 1 is a first user, further comprising:
the collection of identifying information about a second individual being a second user;
the creation of a second individual user profile;
wherein the second user may access the family graph of the first user;
wherein the identifying information about family members is automatically updated to reflect a plurality of relationships to the second user; and
wherein the family graph is auto-generated to display the updated identifying information.

4. The method for displaying family relationships of claim 1, wherein an individual user profile is created from the following identifying information: a first name, a last name and a date of birth.

5. The method for displaying family relationships of claim 1, wherein the family profile is created from at least one of or a combination of the following identifying information: a photograph or picture, a family title, a family description, or a family member having a relationship identifier to the first user.

6. The method for displaying family relationships of claim 1, wherein the collection of identifying information about at least one family member of the individual may be implemented as many times as the individual has family members, and wherein there is no limit to the number of family profiles that may be connected as displayed in the family graph.
